(19) United States
(12) Patent Application Publication
(10) Pub. No.: US 2008/0096710 A1
(43) Pub. Date: Apr. 24, 2008

(54) Plate-link chain with convex-concave contact of the rocker members

(75) Inventor: Nicolae Souca, Baden-Baden (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/974,680

(22) Filed: Oct. 15, 2007

Related U.S. Application Data
(63) Continuation of application No. PCT/DE2006/000523, filed on Mar. 24, 2006.

(30) Foreign Application Priority Data
Apr. 15, 2005 (DE) 10 2005 017 346.2

(51) Int. Cl. F16G 5/18

(52) U.S. Cl. 474/245

(57) ABSTRACT

A chain made from a number of links that are connected to each other by a hinge joint including at least one rocker member that includes a rolling surface that rolls against a rolling surface on a corresponding chain link. The rocker member is in contact with the corresponding link at least two further points, and the surface contours of the corresponding link and the rocker member are corresponding contoured curves in a region adjacent to the contact points. The load-bearing capacity in the form of the transmittable tensile force is further increased when one of the rolling surfaces is convex and one of the rolling surfaces is concave.

The present invention relates to a plate-link chain made up of a plurality of plates which are each connected with each other through a link comprising at least one rocker member.

Plate-link chains are known in a large number of versions, for example from DE 38 26 809 with additional references or from DE 30 27 834, in which various connections are depicted. EP 0 800 018 for example describes in addition a conical pulley transmission with continuously adjustable gear ratio, in which such plate-link chains may be employed.

With known plate-link chains the problem arises that the rocker members which are in contact with each other do not carry out a pure rolling motion on each other when the chain is deflected. The rolling profiles of the surfaces which are in contact with each other are usually carried out as segments of a circle, which kinematically could perform a pure rolling motion. When the chain is deflected however, the contact surfaces of the rocker members with the plates are shaped in such a way that a sliding motion of the rocker members against each other occurs in addition.

To solve this problem, in 102 01 979 A1 a genre-defining plate-link chain is proposed, whose joint pieces that connect the individual chain links are designed as pairs of rocker members that transmit the frictional forces between the pulleys and the plate-link chain and that are inserted into the recesses in the plates. At the same time the rocker members have surfaces oriented toward each other, which roll on each other when used as intended. The shape of the rocker members is such that the rolling profiles are centroids.

The object of the present invention is to further increase the load bearing capacity of such a plate-link chain, i.e. in particular the transmissible tensile forces. In addition, the noise emission in operation is to be reduced.

This problem is solved by means of a plate-link chain made up of a plurality of plates, which are connected to each other through a joint comprising at least one rocker member that can roll with a rolling profile on a rolling profile assigned to an opposing plate, where the rocker member is in contact with the opposing plate on at least two additional points, and the surface contours of the opposing plate and of the rocker member in a zone around the contact points (K, K′) are reciprocally contoured curves, with one of the rolling profiles being concave and one of the rolling profiles being convex.

If one considers a joint of such a plate-link chain, there are plates situated on both sides of it. In order to be able to differentiate between these plates, which—regarded individually—may be identical components, for the purposes of the present patent application they are referred to here as plates and opposing plates. If one cuts a joint free in a two-piece group of a plate-link chain, then the plates that project in the one direction are designated as such, while the plates that project in the other direction are designated as opposing plates. If one were to cut free an adjacent joint, the designations from the perspective of the previously considered plate would be reversed. The characterizations plate and opposing plate therefore serve in the context of the present patent application merely to designate different plate functions with regard to a single joint. Rocker member is understood here in a known manner in particular as a pin that is part of the joint and that joins together a plurality of plates in the transverse direction of the chain; the plates thereby form a chain link. The rolling profile of the rocker member or members, as well as the rolling profile assigned to the opposing plate, may have any contour desired, for example circular or parabolic. A rolling profile assigned to the opposing plate is understood in the meaning that it is either applied directly to the plate or is connected to the plates that form a chain link, in the manner of a rocker member. The property of the rocker member being in contact with at least two additional points of the opposing plate is understood here in the meaning that they have sliding or rolling contact or both simultaneously, over an area or at a point or in a line. As a rule this will be a point-shaped contact in a two-dimensional representation, and a linear contact in a three-dimensional representation. The formulation “in a zone around the contact points” is intended to express that when the chain is operated as intended, where a deflection of the chain joints with respect to each other is to occur up to a definable value, the contact points slide against and on each other only within a certain zone. Thus if one considers a non-deflected chain, the contact point will be located at a particular place. In contrast, in a chain that is deflected maximally to both sides this contact point will be located at a different place. Outside of these zones in which the contact points come to be located, a geometry that deviates from the kinematic conditions described here may be chosen. Reciprocally contoured curves are understood here in particular to mean pairs of curves such as occur alternately as one rolling profile rolls on another rolling profile. So for example if one lets two circles roll on each other, then as the one circle rolls on the other circle, a point that lies on the one circle will describe an involute in space. If on the other hand one lets the other circle roll while the first circle is held in place, a point of relatively fixed location there will likewise describe an involute. The two involutes are reciprocal to each other. The formulation reciprocally contoured curve is intended to make clear that depending on the plates or rocker members, depending on the relative angular position of two chain links to each other, different areas of the plates or rocker members may come into contact with each other. If one lets these different areas each describe an involute as the corresponding rolling profiles roll off, the respective contoured curves of these involutes describe a kinematically compatible solution. An example of such a kinematically compatible solution occurs for example when the rocker member is designed in the intended contact area as an involute, so that the contact area of the plate directly yields a reciprocal involute. Both curves are thus already inherently involutes, so that the family of curves that different points on the involute execute during relative rolling of the rolling profiles produce the same identical involute.

Preferably, the reciprocally contoured curves are in each case involutes of the base circles assigned to the rolling profiles, or envelopes of a family of involutes through surface points of the opposing plate or of the rocker member.

A preferred embodiment contains the provision that the rolling profile of the rocker member is convex and the rolling profile assigned to the opposing plate is concave, or that the rolling profile of the rocker member is concave and the rolling profile assigned to the opposing plate is convex. The contact between the rocker members is convex-concave (internal engagement of involutes) or convex-convex (external engagement of involutes). The convex-concave contact results in lower Hertzian contact pressures with the same curvature of the convex rocker members.

With the same curvature of the rocker members, greater forces can be transmitted; the same forces can be transmitted with rocker members having greater curvature (i.e. smaller radii of curvature). Smaller radii of curvature of the rocker members permit smaller dimensions of the chains. This pairing results in lower Hertzian unit surface pressure compared to a convex-convex pairing. One result is that the performance of the chain can be increased, measured by its continuous loading capacity in terms of transmitting tensile forces or its service life.

Preferably there is provision for a common normal of the contour of the rocker member and of the contour of the plate to go through the instantaneous center of rotation at the contact points. In this way, sliding takes place without undercutting. With undercutting, one of the bodies would have to penetrate into the other body (as for example in production by machining). Such a system would not be kinematically compatible. In contrast, the measure presented here ensures that as the surfaces rolling on each other rotate around their current instantaneous pole, the respective other contact points can slide in a kinematically compatible manner. At the same time, this also prevents the two surfaces from losing contact with each other, which would give rise to free play. The expression “remain in contact” must of course be seen here within the framework of manufacturing tolerances.

A preferred embodiment also includes the provision that another rocker member is assigned to the opposing plate. So the (first) rocker member does not roll directly on the opposing plates, but on another rocker member that connects the opposing plates with each other.

In this case there is preferably provision for the rocker member to be solidly connected to the plate and for the other rocker member to be solidly connected to the opposing plate.

The problem named at the beginning is also solved by a plate-link chain made up of a plurality of plates which are each connected to each other by at least one rocker member, where the rocker member can slide with a rolling profile on a rolling profile assigned to the opposing plate and the rolling profile is in contact with the rolling profile of the opposing plate at least two points, the surface contours of the rolling profiles in a zone around the contact points being reciprocally contoured curves. Instead of a rolling motion of the rocker member on an assigned rolling profile for example of another rocker member and additional sliding motions of the rocker member on corresponding opposing surfaces of the plates, which is intended to cause a fixing of the rocker member or members transversely to the longitudinal direction of the chain, in particular when the chain is bent, here a pure sliding motion of the rocker member or members relative to each other takes place. Instead of three contact points as described earlier, of which one performs a rolling motion and two others perform sliding motions, in this way only two contact points per plate are necessary, both of which perform a sliding motion.

A refinement also contains the provision that a common normal of the contour of the rolling profiles at the contact points goes through the instantaneous center of rotation. Kinematically, this means that the instantaneous centers of rotation of the sliding motions at the contact locations and the instantaneous center of rotation of the generating or rolling motion converge. The geometry of all the interacting bodies is thus kinematically compatible with their motion; no undercutting takes place that would cause a deformation of the bodies.

A refinement also includes the provision that one of the rolling profiles is concave and the other of the rolling profiles is convex. That reduces the Hertzian contact pressure at the contact points.

A refinement also includes the provision that the rocker member is not solidly connected to any of the plates, and that both plates have rolling profiles on which rolling profiles of the rocker member can roll or slide. The rocker member supported as a “floating pin” works in combination with the other parts kinematically only through rolling and sliding motions. Slipping out in the axial direction of the rocker member, which is the same as a direction transverse to the axial direction (direction of motion) of the chain as such, can be caused by beading, splints or the like. In a bevel gear set, this guidance is provided by the bevel gears, there being no guidance taking place between the bevel gears.

A refinement also includes the provision that the rolling profiles are situated on rocker members that are firmly connected to the respective plates. As an alternative to a freely supported rocker member, which is supported on two other profiles that are assigned to the plates—including for example in the form of rocker members connecting a plurality of plates—, the rocker members may also be firmly connected to one of the plates. In this case, a rocker member that is firmly connected to a plate slides or rolls on rolling profiles that are build directly into the plates, or on another rolling profile that likewise connects a plurality of plates with each other into a chain link.

A refinement also includes the provision that both rolling profiles of the rocker member are convex, and the rolling profiles of the rocker members of the plates are concave. It can also be provided that both rolling profiles of the rocker member are concave, and the rolling profiles of the rocker members of the plates are convex. So a concave profile always rolls with a convex profile. This can also be achieved if one of the profiles of the rocker member is concave and the assigned profile of the plates is convex, while the other profile of the rocker member is convex and the assigned profile of the plates is concave.

A refinement further includes the provision that the rocker member is in sliding contact with both plates at two points each, and can roll on both rolling profiles on one point each. Alternatively, it can be provided that the rocker member is in sliding contact with both rolling profiles at two points each.

Instead of the rocker members being grasped by the plates, i.e. the rocker members being supported in openings in the plates, the plates may be grasped by the rocker members. In that case preferably two opposing rocker members are firmly connected with each other.

The problem named at the beginning is also solved by a plate-link chain made up of a plurality of plates which are joined together to make links, where the rocker members grasp the plates.

A refinement also includes the provision that the surface contours of the plate and of the rocker members in a zone around the contact points are reciprocally contoured curves, and one of the rolling profiles is concave and one of the rolling profiles is convex. A refinement also includes the provision that both rolling profiles of the rocker member are convex, and the rolling profiles of the rocker members are concave. Alternatively, it is provided that the rolling profiles of the plates are convex, and the rolling profiles of the rocker members are concave.

The problem named at the beginning is also solved by a conical pulley transmission having a plate link chain according to one of the previous claims.

Exemplary embodiments of the invention will now be explained on the basis of the accompanying drawing. The figures show the following:

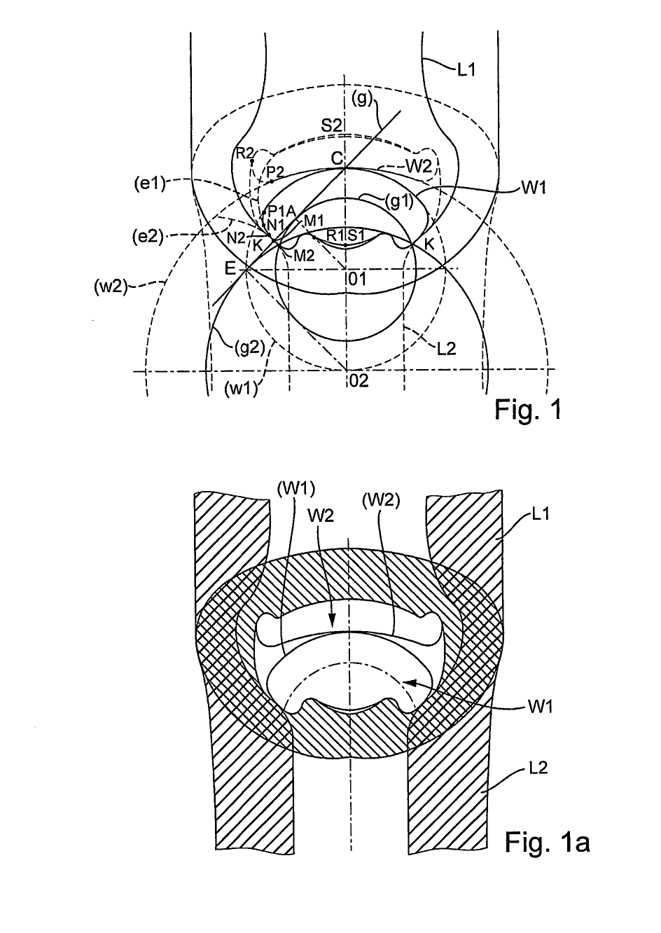

FIG. 1a: a sketch of plates and rocker members of a joint of a plate-link chain;

FIG. 1: a schematic depiction of the geometry and kinematics of a joint of a plate-link chain;

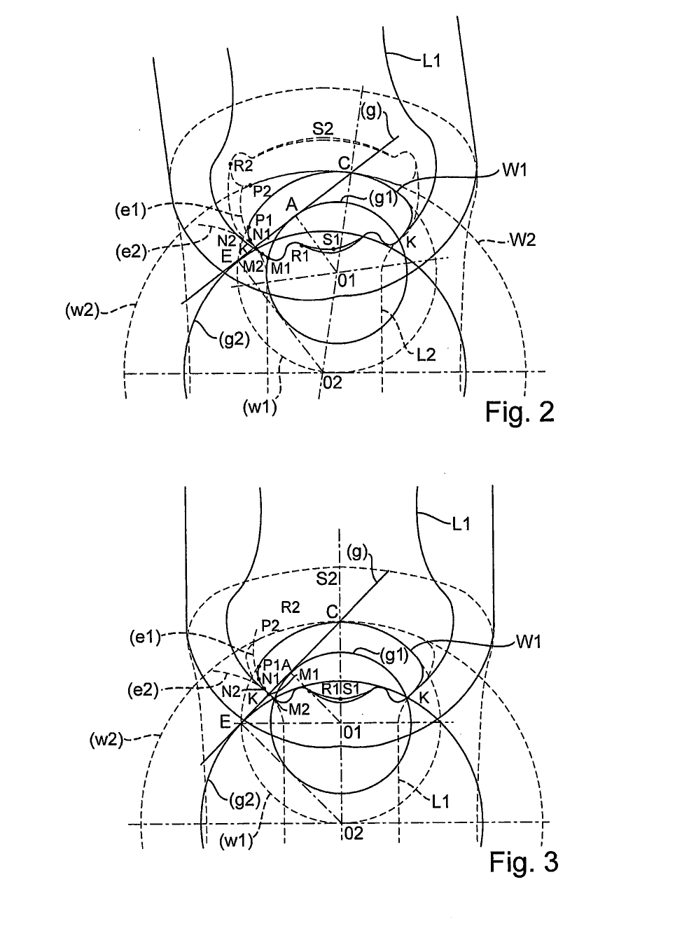

FIG. 2: a schematic depiction of the kinematics of a joint of a plate-link chain with chain links deflected relative to each other;

FIG. 3: an alternative embodiment with only one rocker member in the joint;

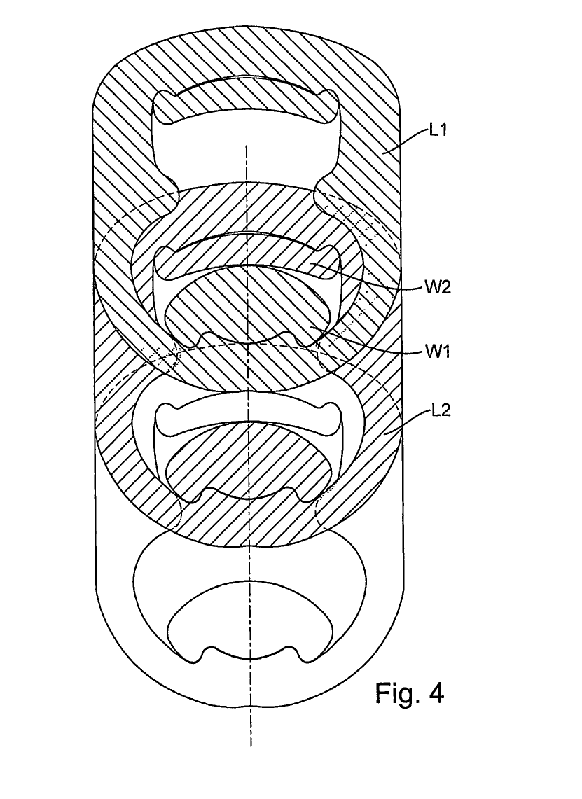

FIG. 4: a part of a chain having a plurality of plates;

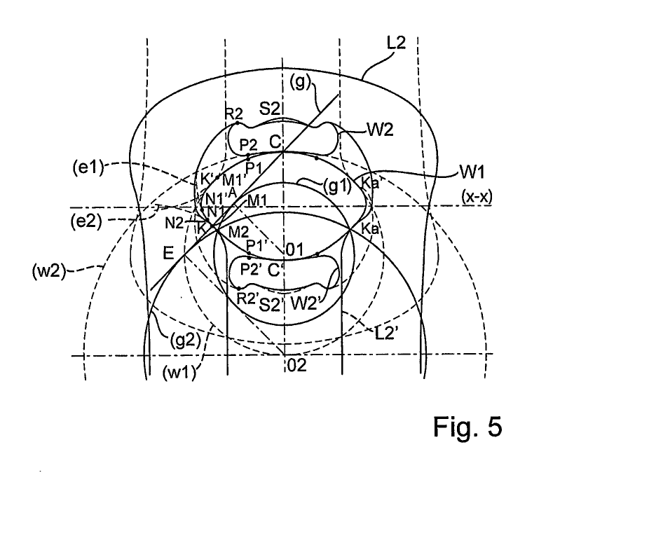

FIG. 5: a joint with floating pin as rocker member;

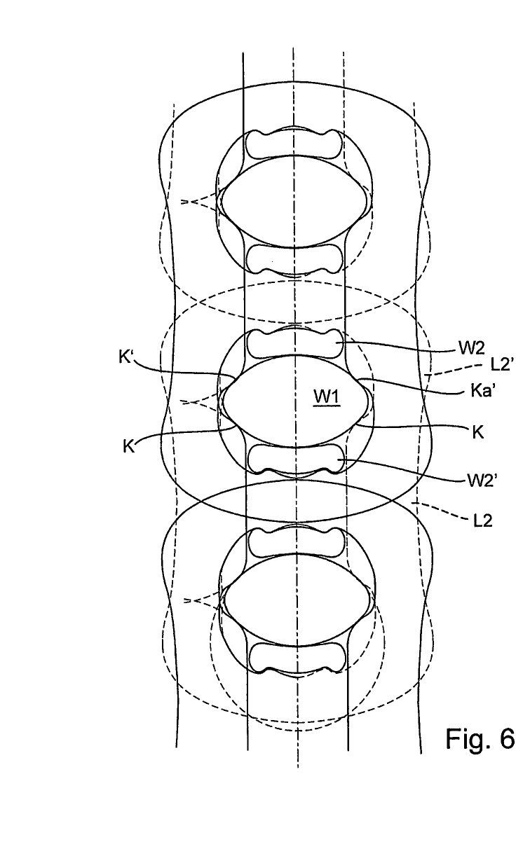

FIG. 6: a part of a chain with a plurality of plates and joints according to FIG. 5;

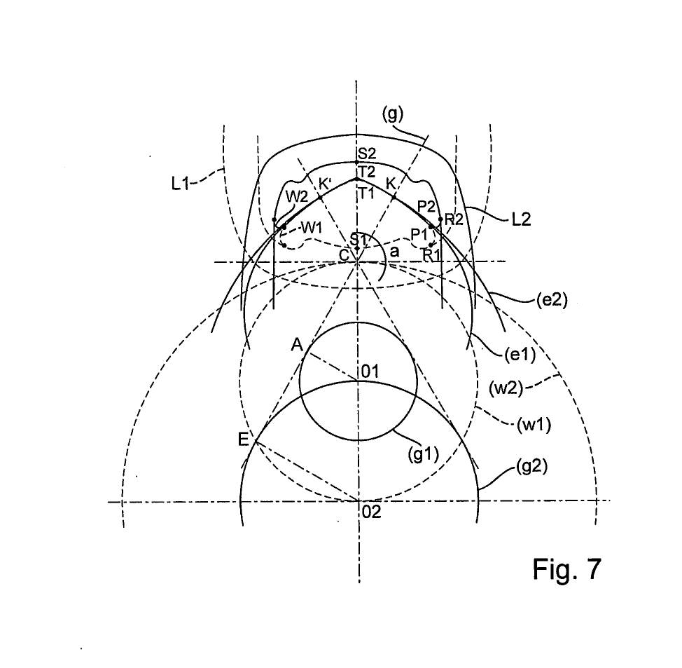

FIG. 7: a joint with sliding rocker member;

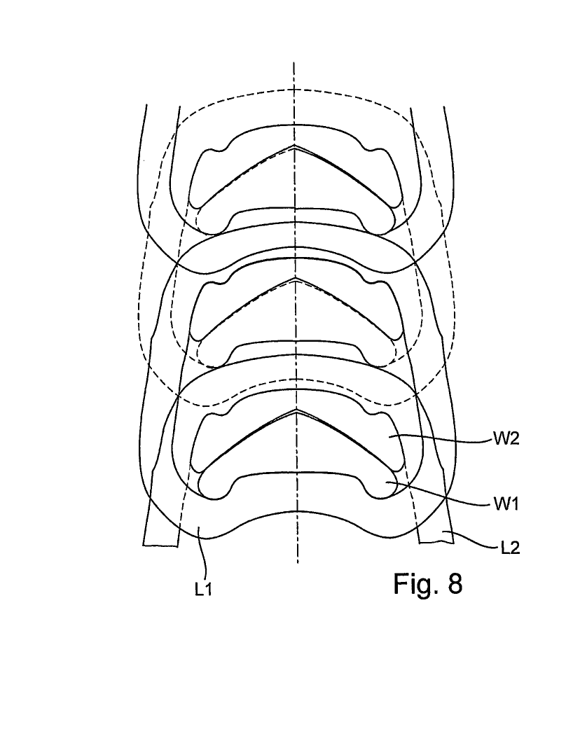

FIG. 8: a part of a chain with a plurality of plates and joints according to FIG. 7;

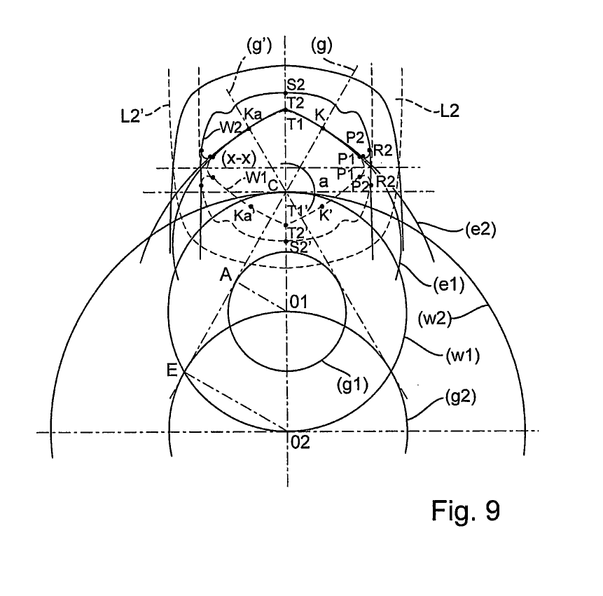

FIG. 9: a joint with sliding rocker member (floating pin);

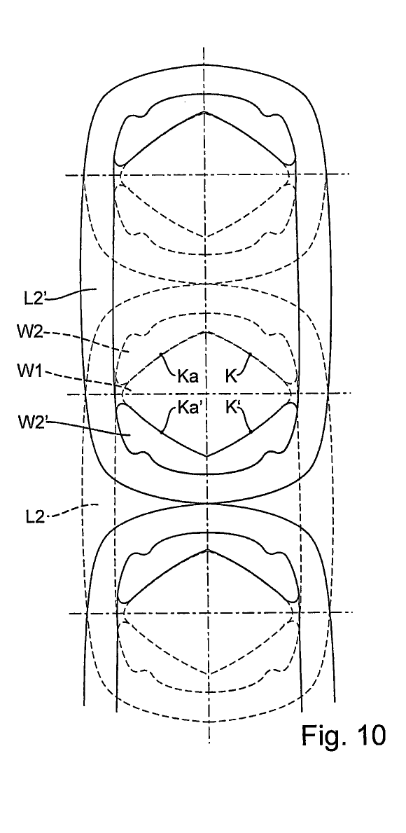

FIG. 10: a part of a chain with a plurality of plates and joints according to FIG. 9;

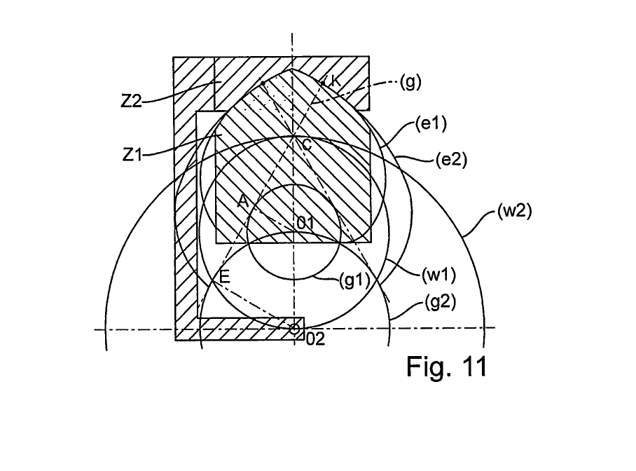

FIGS. 11: through 14: an embodiment of a joint with concave rolling profile of the floating pin;

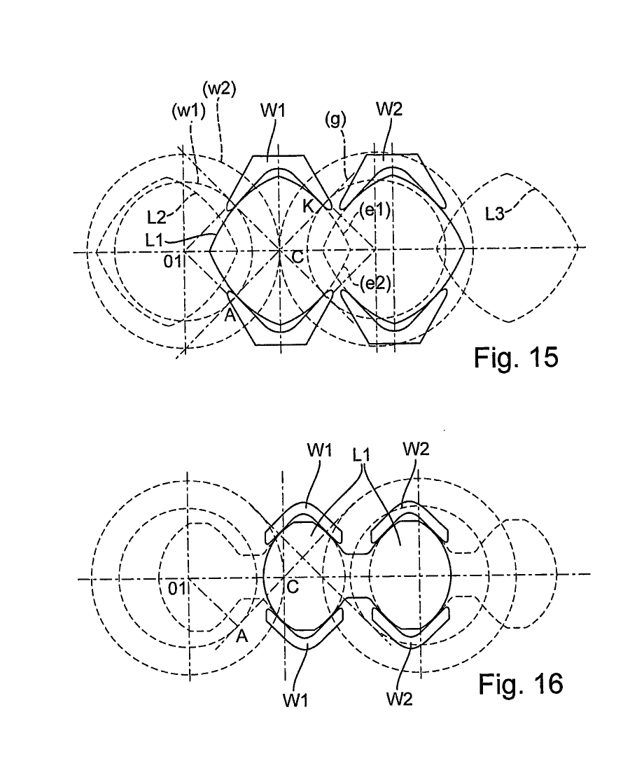

FIGS. 15 and 16: an embodiment of a joint with rocker members that grasp the plates;

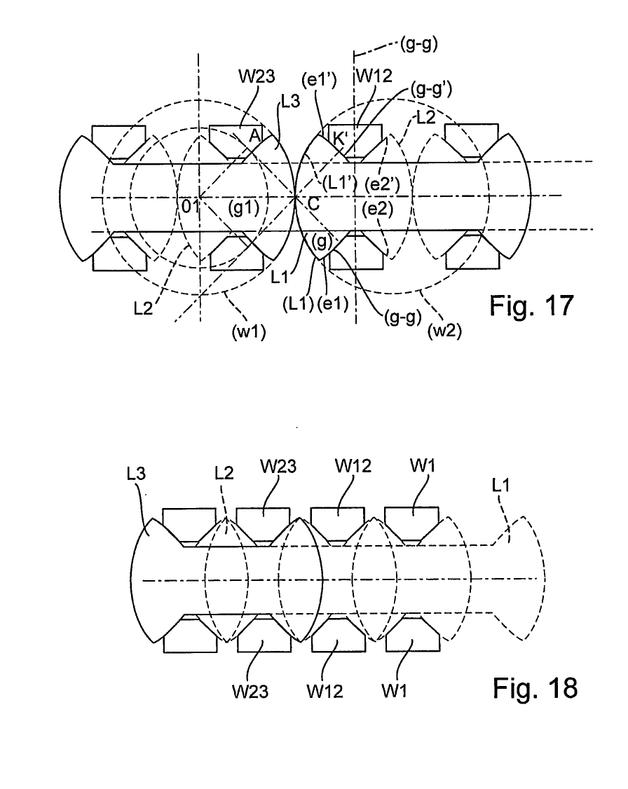

FIGS. 17 and 18: a further embodiment of a joint with rocker members that grasp the plates.

FIG. 1 and FIG. 1a show a detail of a plate link chain. In FIG. 1a, subsidiary lines and large parts of the labels have been suppressed for the sake of clarity; otherwise the depicted object corresponds to FIG. 1. The figure depicts a plate L1 and a plate L2. A plate-link chain is made up of a plurality of plates stacked on each other packet-style, as described for example in DE 3027834. Different arrangements are possible here, for example the two-plate or three-plate unit. The execution of the joint is of importance for the present invention; therefore FIG. 1 depicts only two plates joined to each other flexibly in the area of the joint. The joint includes two rocker members W1 and W2. In FIG. 1a the rocker members are identified with hatching in varying orientations; areas in which the hatching overlaps are areas in which the plate that is in front in the depiction overlaps the rear one. The rocker members are firmly connected to a plate; here rocker member W1 is connected to plate L1 and rocker member W2 to plate L2. The rocker members join several plates of the plate-link chain to each other; this is not depicted here, however. The rocker members roll on each other on rolling profiles (w1) and (w2). In the present invention the rolling profiles are circle segments, but they could just as well be segments of ellipses, parabolas or the like.

The circular arcs C-P1 and C-P2 of the rolling circles (w1) with center point 01 and (w2) with center point 02 form the rolling profiles of rocker members W1 and W2 (see FIG. 1). The line of action (g) is tangential at A and E to the base circles (g1) and (g2), and contains the instantaneous center of rotation C of the relative motion of the rolling profiles. A point K on the line of action describes the involutes (e1) and (e2) during the rolling motion on the base circles. The two involutes are in contact at point K. Plates L1 and L2 are firmly connected to the rocker members through the attachment profiles M1-R1-S1 and R2-S2. An involute arc M1-K-N1 of the involute (e1) is formed on rocker member W1 as guide profile. A conjugated guide profile, the involute arc M2-K-N2 of the involute (e2), is formed on plate L2. The involute (e1) comes about conceptually through the rolling of rocker member W1 on firmly held rocker member W2; correspondingly, involute (e2) comes about by the rolling of rocker member W2 on rocker member W1. The involutes are therefore reciprocal to each other. Connecting profile P1-N1 establishes the connection between the guide profile and the rolling profile of rocker member W1, while connecting profile P2-R2 establishes the connection between the rolling and attachment profiles of rocker member W2. At the connecting points the two profiles have a common tangent. The connecting profiles can be formed in any way desired from various curve arcs and straight lines, according to geometric, kinematic and strength criteria.

To create complete and kinematically compatible guidance of rocker member W1 relative to rocker member W2 and the latter's plate L2, rocker member W1 must be supported at three points. For that reason, the entire described geometry is copied symmetrically to axis 01-02. Rocker member W1 will then be in contact with rocker member W2 and the latter's plate L2 at the points K, C and K′.

When plate L1 rotates in relation to plate L2, rocker members W1 and W2 roll on their rolling profiles (W1) and (W2). From the perspective of the rolling profile (W1) and of the associated plate L1, the rolling profile (W1) is a polode or moving centrode, i.e. the locus of the instantaneous center of rotation at different angles of the plates with respect to each other; correspondingly, the rolling profile (W2) is a polode or moving centrode from the perspective of plate L2 or of rocker member W2. Rocker members W1 and W2 do not slide here, but rather always roll on each other, so that only a rolling motion of the two rocker members relative to each other occurs, not a sliding motion. In the exemplary embodiment in FIG. 2, rocker member W1 is constantly in contact with plate L2 at points K and K′. As explained earlier, the contour of rocker member W1 around contact point K or K′ is an involute to the base circle (g2) of rocker member W2. Correspondingly, the surface contour of plate L1 in the area around contact points K and K′ is an involute to the base circle (g1) of rocker member W2. The result of this is that a normal to the (common) tangent of both involutes at contact point K or K′ always goes through the instantaneous center of rotation C. Kinematically, this means that with a rotation around the instantaneous center C a sliding motion is possible between plate L2 and rocker member W1 at contact points K or K′.

The involute profiles M1-K-N1 of rocker member W1 and M2-K-N2 of plate L2 form an internal engagement of involutes, whose rolling circles are the rolling profiles (W1) and (W2) of the rocker members (consequently the routes C-P1 and C-P2). The thickness and width of the rocker members, the thickness and shape of the plates, the attaching profiles between the rocker members and plates are determined from strength, acoustics, material selection and other criteria.

An arbitrary relative position of the chain links is depicted in FIG. 1. If rocker member W2 is dispensed with, plate L2 can contain the rolling profile directly and can directly engage rocker member W1 (FIG. 3).

FIG. 3 shows an alternative embodiment in which rocker member W2 is lacking, so that plate L2 has the rolling profile (W2) directly. Thus plate L2 is directly engaged with rocker member W1.

As can be recognized from FIGS. 1 through 4, rolling profile (W1) is convex in shape while rolling profile (W2) is concave. Hence this involves an engagement of a convex with a concave profile, so that an extrapolar involute internal engagement results. Several chained links are depicted in FIG. 4.

The relative motion of the rocker members is a pure rolling motion (rolling without sliding). The rocker members are in contact at the instantaneous center of rotation C. The common normal of the involutes at contact point K is always the line of action, and in every relative position contains the instantaneous center of rotation or pole of engagement C. This is a prerequisite of a kinematically compatible centroidal motion between the links of the chain. In contrast to the normal involute engagement, which transmits the forces between the involutes at contact point K in the direction of the line of action CK, this engagement transmits the forces between the rocker members W1, W2. These forces are always oriented in the direction of the normals at contact point C of the rolling profiles. If the rocker members are in contact for example with conical disks of a conical pulley transmission, forces can arise between the rocker members and their plates whose resulting force has a different direction than the common normal at the instantaneous center of rotation C. In that case only the components in the direction of the normal are transmitted at contact point C; the other components are transmitted at contact points K, K′ of the involutes.

In the exemplary embodiment described below on the basis of FIGS. 5 and 6, an extrapolar involute internal and external engagement is presented as the kinematic geometry. A floating-supported (“floating-pin”) rocker member is suspended between two other rocker members, whose plates guide the floating-supported rocker member. This solution leads to several kinematic benefits, and can also bring acoustic improvements.

FIG. 5 explains the construction of the joint. In contrast to the previously depicted exemplary embodiment, a floating-supported rocker member W1 which, as a “floating pin,” is not firmly connected to any of the plates, rolls on two rocker members W2 and W2′, each of which is firmly connected to one of the plates L2, L2′. To make analogies to the first exemplary embodiment easier to understand, the labeling for the rocker members and plates has been chosen so that kinematically comparable parts are named similarly. The circular arcs C-P1 and C-P2 of the rolling circles (w1) with center point 01 and (w2) with center point 02 form the rolling profiles of rocker members W1 and W2 (FIG. 1). The rolling circles can be internally or externally tangential; that is, they can form an internal or external involute engagement. The line of action (g) is tangential at A and E to the base circles (g1) and (g2), and contains the instantaneous center of rotation C of the relative motion of the rolling profiles. A point K on the line of action describes the involutes (e1) and (e2) during the rolling motion of the line of action on the base circles. The two involutes are in contact at point K. Plate L2 is firmly attached to rocker member W2 through the attachment profile R2-S2. An involute arc M1-K-N1 of the involute (e1) is formed on rocker member W1 as guide profile. The involute arc M2-K-N2 of involute (e2) forms a guide profile of plate L2. Connecting profile P2-R2 creates the connection between the rolling and attaching profiles of rocker member W2. At the connecting points the two profiles have a common tangent. The connecting profile can be formed in any way desired from various curve arcs and straight lines, according to geometric, kinematic and strength criteria.

To create complete and kinematically compatible guidance of rocker member W1 relative to rocker member W2 and the latter's plate L2, rocker member W1 must be supported at three points. For that reason, the entire described geometry is copied symmetrically to axis 01-02. Rocker member W1 will then be in contact with rocker member W2 and the latter's plate L2 at the points K, C and Ka.

The involute profiles M1-K-N1 of rocker member W1 and M2-K-N2 of plate L2 form an extrapolar internal engagement of involutes or external engagement of involutes, whose rolling circles are the rolling profiles (W1) and (W2) of the rocker members. The thickness and width of the rocker members, the thickness and shape of the plates, the attaching profiles between the rocker members and plates are determined from strength, acoustics, technology and other criteria.

Rolling profile C-P1 and guide profile M1-K-N1 of rocker member W1 are copied symmetrically around an axis of symmetry (x-x) perpendicular to 01-02 and become rolling profile C′-P1′ and guide profile C′-M′-K′-N1′. Profile N1-N1′ of rocker member W1, as a connecting profile, can be configured in any way desired. The profiles C-P1-M1′-K′-N1′-N1-K-M1-P1′-C′ form one half of the floating-supported rocker member (floating pin) W1. The other half is formed symmetrical to the 01-02 axis. A plate L2′ with its own rocker member W2′ corresponds to a symmetrical depiction around the axis (x-x) of plate L2 and the latter's rocker member W2. The two plates L2 and L2′ with the associated rocker members W2 and W2′ form a double joint with the floating-supported rocker member (floating pin) W1. Each plate with its rocker member forms a joint with rocker member W1, wherein the relative motions are centroidal motions (rolling motions along the fixed centrode, which here is circular), and thus the previously named conditions of the kinematic geometry are fulfilled. Since rocker member W1 is suspended between rocker members W2 and W2′ with their plates L2 and L2′, it is called a floating pin. All three rocker members, or only rocker member W1, may come in contact with pulleys of a continuously-variable transmission. The axial motions of rocker members W1, W2 and W2′ must in any case be limited, however. Several chained links are depicted in FIG. 2.

As may be recognized from FIGS. 5 and 6, rocker member W1 is engaged with each of the two plates at two locations; these are the points K, K′, Ka and Ka′. What was said earlier also applies to these points: normal tangents at these points go through the instantaneous center C or C′. Rocker member W1 rolls on rocker members W2 and W2′ at points C and C′, respectively; at points K, K, Ka and Ka′ a pure sliding motion of the plates on rocker member W1 takes place.

In order to create a better polygonal effect, rocker members W2 and W2′ can be dispensed with. Plates L2 and L2′ can contain the rolling profiles of the rocker members directly (analogous to the design depicted on the basis of FIG. 3), and roll directly on rocker member W1.

The relative motions of rocker members W1-W2 and W1-W2′ are pure rolling motions (rolling without sliding). The rocker members are in contact at the instantaneous centers of rotation C and C′. The common normals of the involutes at the contact point are always the lines of action, and contain the poles of engagement (instantaneous centers of rotation) C and C′ in every relative position. In contrast to the usual involute engagement, which transmits the forces between the involutes at contact point K in the direction of the line of action CK, this engagement transmits the forces between the rocker members. The forces are always directed perpendicular to the common tangent of the rolling profiles at contact point C. If the rocker members are in contact for example with conical disks, forces can arise between the rocker members and their plates whose resulting force has a different direction than the common normal at the instantaneous center of rotation C. In that case only the components in the direction of the normal are transmitted at the instantaneous center of direction C; the other components apply stress to contact points K, K′ of the involutes.

The joint is actually a double joint between two adjacent chain links (plates); this results in a larger angle between two adjacent plates and reduces a negative polygonal effect.

If the rocker members W2 and W2′ are missing from the joint, the plates L2 and L2′ can contain the active profiles of the rocker members and directly engage the rocker member W1. The plates can be kept shorter, and the negative effects of the polygonal effect can be further reduced. The point of application of the force between the rocker members in contact is the contact point of the rolling profiles, and wanders over the rolling profiles. The wandering of this point is smaller with convex-convex contact. The floating-supported rocker member has good bending strength and buckling stability.

Higher forces can be absorbed in contact with a conical disk of a conical-pulley transmission, since a larger contact surface exists. Either all three pins (rocker members) of the joint can be in contact with the conical disks, or only the floating pin. The normal pins have a pivoting rotation on the conical disk, which causes greater wear. The floating pin has no pivoting rotation. The wear on the conical disks is reduced, and the chain and the conical disks have a longer service life. Good force transmission and chain stability can be achieved through an optimal pressure angle. The pressure angle determines the shape and the dimensions of the rocker members and plates, and thereby influences the strength, the acoustics and the joint stability.

The floating pin (floating rocker member) is suspended between two conjugated rocker members that roll on the rolling profiles, and in whose plates it is guided. The polygonal effect can be improved additionally by dispensing with rocker members W2 and W2′; the plates come directly into contact with the floating pin. The plates become shorter, and the distance between two adjacent joints thereby also becomes shorter. The distances between two adjacent joints are smaller, and thus better acoustic properties can be expected.

The three rocker members of the joint can be used to increase the transmissible torque of a CVT transmission, since they have greater buckling and bending strength. Wandering of the contact point is greater with involute internal engagement than with involute external engagement. This disadvantage can be compensated for (at least partially) by letting the rocker member have a smaller radius of curvature.

FIGS. 7 and 8 show another alternative embodiment of a plate-link chain according to the invention. In contrast to the embodiments already depicted, no rolling motion takes place between the various rocker members, but rather a sliding motion. The rocker members are in a position here to fix the chain links with respect to each other both in the direction of motion of the chain (axially) and perpendicular thereto. With this exemplary embodiment it is therefore not necessary that the rocker members transmit a force directly to the plates. In the following exemplary embodiment, an involute internal engagement is presented as the kinematic geometry of the chain joint.

FIG. 7 explains the construction of an additional embodiment of the joint. The rolling circles (w1) with the center point 01 and (w2) with the center point 02 have a common tangent at point C. They represent the centroids of the relative motion. The line of action (g) is tangential at A and E to the base circles (g1) and (g2), and contains the instantaneous center of rotation C of the relative motion of the centroids. A point K on the line of action describes the involutes (e1) and (e2) during their rolling motion on the base circles. The two involutes are in contact at K. Plates L1 and L2 are firmly connected to the rocker members W1 and W2 through the attachment profiles R1-S1 and R2-S2. The involute arcs P1-K-T1 of the involute (e1) and P2-K-T2 of the involute (e2) are situated on the rocker members W1 and W2 as active profiles. The connecting profiles P1-R1 and P2-R2 are the connection between the active profiles and attachment profiles of rocker members W1 and W2. The connecting profiles can be formed in any way desired from various curve arcs and straight lines, according to geometric, kinematic and strength criteria. The two profiles have a common tangent at the connecting points.

The entire described geometry is copied symmetrically to axis 01-02. Rocker member W1 is then in contact with rocker member W2 and the latter's plate L2 at the points K and K′.

The involute profiles P1-K-T1 of rocker member W1 and P2-K-T2 of rocker member W2 form an internal involute engagement, whose rolling circles (w1) and (w2) are virtual centroids of the relative motion. Several chained links are depicted in FIG. 8.

If one of the rocker members is dispensed with, a plate can contain the active profile and engage the conjugated rocker member directly. That can result in smaller dimensions of the joint, and reduce the negative effect of the polygonal effect. The relative motion of the rocker members theoretically represents a pure rolling motion (rolling without sliding) of the non-embodied rolling circles (w1) and (w2). In reality, the rocker members roll and slide reciprocally on the active profiles during the rolling motion of the rolling circles. The rocker members are always in contact at two points, namely K and K′. The common normal of the involutes at contact point K or K′ is always the line of action, and in every relative position contains the instantaneous center of rotation (pole of engagement) C. The forces between the involutes at contact points K and K′ are transmitted in the direction of the lines of action CK and CK′. Because of the sliding motion between the active profiles of the rocker members, friction forces will also arise at points K and K′. The pressure angle α is important for the friction forces and the stability of the joint with regard to the bias of the relative rotary motion of the rocker members around the 01-02 axis. The joint has an efficiency comparable to that of the involute engagement.

FIG. 9 explains the construction of an additional embodiment of the joint. The rolling circles (w1) with the center point 01 and (w2) with the center point 02 have a common tangent at point C. They represent the centroids of the relative motion. The line of action (g) is tangential at A and E to the base circles (g1) and (g2), and contains the instantaneous center of rotation C of the relative motion of the centroids. A point K on the line of action describes the involutes (e1) and (e2) during their rolling motion on the base circles. The two involutes are in contact at K. The involute arcs P1-K-T1 of the involute (e1) and P2-K-T2 of the involute (e2) are embodied on the rocker members W1 and W2 as active profiles. The active profile P2-K-T2 of rocker member W2 is connected with attachment profile R2-S2 by connecting profile P2-R2. The profiles have a common normal at the connecting points. The involute profiles P1-K-T1 of rocker member W1 and P2-K-T2 of rocker member W2 form an internal involute engagement, whose rolling circles (w1) and (w2) are virtual centroids of the relative motion. The attaching and connecting profiles can be formed in any way desired from various curve arcs and straight lines, according to geometric, kinematic and strength criteria.

Perpendicular to the axis 01-02, an axis of symmetry (x-x) is chosen between the selected active profiles and the instantaneous center of rotation C. If the axis of symmetry contains the instantaneous center of rotation, this can result in beneficial kinematic and dynamic properties. The profile P1-K-T1 and its symmetrical profile P1′-K′-T1′ represent the active profiles of the same rocker member, and are connected with a connecting profile P1-P1′ of any form desired.

Symmetrical mirrored profiles of rocker member W2, namely T2′-K′-P2′-R2′-S2′, represent the profiles of rocker member W2′, which comes into contact with the active profile of rocker member W1 at K′. Here too, rocker member W1 is suspended with floating support between rocker members W2 and W2′. In order to complete the geometry of the chain joint, the entire described geometry is copied around the axis 01-02.

Several chained links are depicted in FIG. 10. The relative motion of the rocker members theoretically represents a pure rolling motion (rolling without sliding) of the rolling circles (w1) and (w2). In reality, the rocker members roll and slide reciprocally on the active profiles during the rolling motion of the rolling circles. Rocker member W1 (floating pin) is always in contact with rocker member W2 at the two points K and Ka, and with rocker member W2′ at the two points K′ and Ka′. As long as the force between two adjacent plates results in a tensile force, the position of rocker member W1 between rocker members W2 and W2′ is fully defined. The common normals of the involutes at the contact points K, K′, Ka and Ka′ are always the lines of action, and contain the pole of engagement (instantaneous center of rotation) C in every relative position. The forces between the involutes at the contact points are transmitted in the direction of the lines of action. Because of the sliding motion between the active profiles of the rocker members, friction forces also arise at the contact points. The pressure angle α is important for the friction forces and the stability of the joint with regard to the bias of the relative rotary motion of the rocker members. This joint also has efficiency comparable to that of the involute engagement.

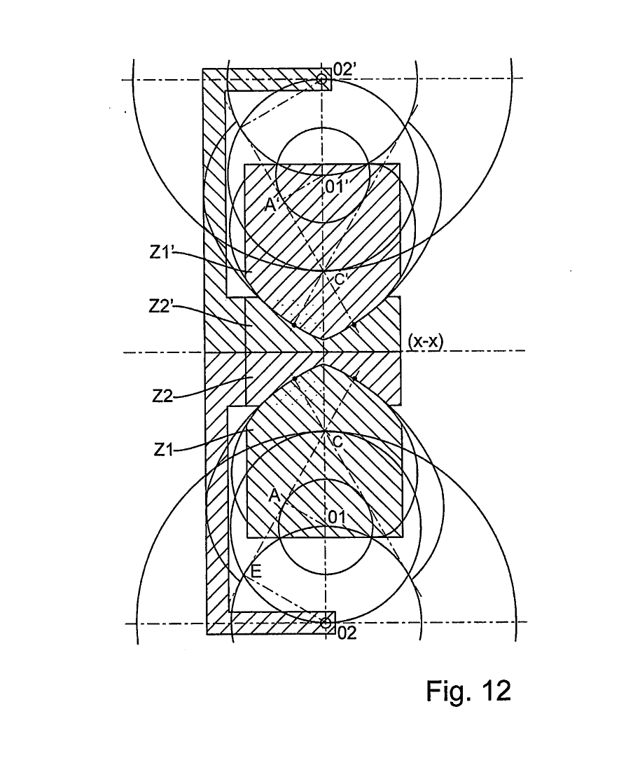

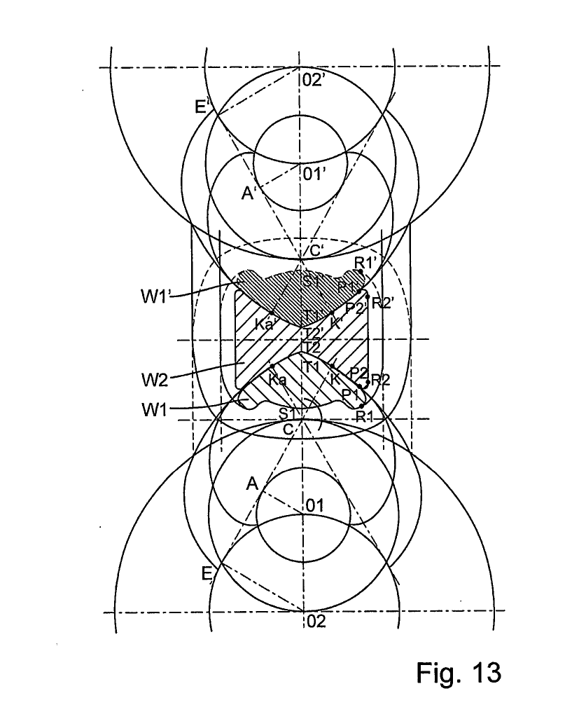

FIG. 11 through FIG. 14 explain the construction of an additional embodiment of the joint. The rolling circles (w1) with center point 01 and (w2) with center point 02, internally tangential at point C, represent the rolling circles of the relative motion (FIG. 11). The line of action (g) is tangential at A and E to the base circles (g1) and (g2), and contains the instantaneous center of rotation C of the relative motion of the rolling circles. A point K on the line of action describes the involutes (e1) and (e2) during their rolling motion on the base circles. The two involutes are in contact at point K. The bodies Z1 and Z2 are segments of two involute-toothed gear wheels of the internal involute engagements. A different symmetrical engagement with the gears Z1′ and Z2′ is depicted in FIG. 2. The axis of symmetry is perpendicular to the line 01-02 and outside of the point of intersection of the involute (e2) with the axis 01-02. The gears Z2 and Z2′ are joined together into one part. The rocker members W1, W2 and W1′ are shaped to correspond to the three gear bodies (FIG. 13). The involute arcs P1-K-T1 of the involute (e1) and P2-K-T2 of the involute (e2) are shaped to the rocker members W1 and W2 as active profiles. The active profile P2-K-T2 of rocker member W2 is connected with attachment profile P2′-K′-T2′ by connecting profile P2-R2-R2′-P2′. The active profiles of rocker members W1 and W1′ are connected with the attaching profiles R1-S1 and R1′-S1′ by the connecting profiles P1-R1 and P1′-R1′. The profiles have a common normal at the connecting points. The involute profiles P1-K-T1 of rocker member W1 and P2-K-T2 of rocker member W2 form an internal involute engagement, whose rolling circles (w1) and (w2) are virtual centroids of the relative motion. The thickness and width of the rocker members, the thickness and shape of the plates, the attaching profiles between the rocker members and plates are determined from strength, acoustics, technology and other criteria. The attaching and connecting profiles can be formed in any way desired from various curve arcs and straight lines, according to geometric, kinematic and strength criteria. Rocker members W2 and W1′ have the same geometry.

The symmetrical profiles of rocker member W1, T1′-K′-P1′-R1-S1′, represent the profiles of rocker member W1′, which comes into contact with the active profile of rocker member W2 at point K′.

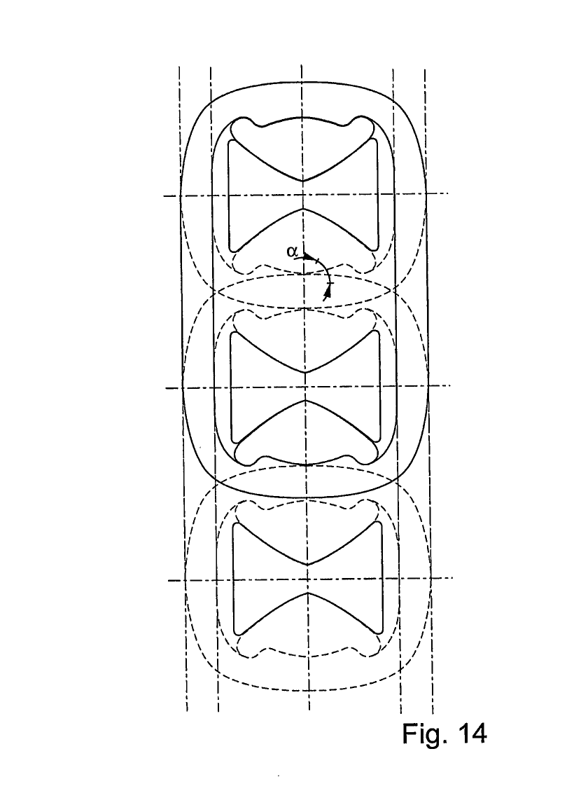

Rocker member W2 is called a floating pin because it is not firmly connected to any element and is suspended between rocker members W1 and W1′. In order to complete the geometry of the chain joint, the entire described geometry is copied around the axis 01-02. Several chained links are depicted in FIG. 14.

The relative motion of the rocker members theoretically represents a rolling motion (rolling without sliding) of the rolling circles (w1) and (w2), which themselves do not find any correspondence on the surface of any of the parts. In reality, the rocker members roll and slide reciprocally on the active profiles during the rolling motion of the rolling circles. Rocker member W1 (the floating pin) is always in contact with rocker member W2 at two points K and Ka, and also with rocker member W2′ at two points K′ and Ka′. As long as the force between two adjacent plates is a tensile force, the position of rocker member W2 between rocker members W1 and W1′ is fully defined. The common normals of the involutes at the contact points K, K′, Ka and Ka′ are always the lines of action, and contain the pole of engagement (instantaneous center of rotation) C in every relative position. The forces between the involutes at the contact points are transmitted in the direction of the lines of action. Because of the sliding motion between the active profiles of the rocker members, friction forces will also arise at the contact points. The pressure angle α (Greek alpha) is important for the friction forces and the stability of the joint in reference to the bias of the relative rotary motion of the rocker members around the 01-02 axis. The joint has an efficiency comparable to the efficiency of the involute engagement.

FIG. 15 and FIG. 16 explain the construction of an additional embodiment of the joint. The rolling curves of the centroidal motion are the circle (w1) with the center point 01 and the rolling straight line (w2); the two have a common tangent (are tangential) at point C (FIG. 15). The line of action (g) is tangential at A in the case of the base circle (g1), and contains the instantaneous center of rotation C of the relative motion of the rolling circle (w1) and of the rolling straight line (w2). A point K on the line of action describes the involute (e1) during its rolling motion on the base circle. Together with the line of action and perpendicular at point K, a generating line (g-g) is regarded. During the rolling motion of the line of action (g) on the rolling circle (w1), the generating line (g-g) describes the same involute (e1). The involute (e1) and the generating line (g-g) are thus reciprocally contoured curves. The two reciprocally contoured curves are in contact at point K. Rocker member W1 is configured so that it contains the generating line as an active profile. The involute (e1) and the active profile of the rocker member are copied symmetrically to the axis 01-C. This results in the profiles (g-g′) and (e1′). An involute gear wheel and rack meshing is obtained, with the rolling circle and rolling straight line that represent virtual centroids of the relative motion of plate and rocker member. Plate 1 includes the two involute profiles of the engagement, and the rocker member includes the two generating lines. The left profile of the plate, the curves (I1) and (I1′), are designed so that they do not collide with the rocker member. The profile of the rocker member is copied symmetrically to (w2), so that it acquires the whole form as depicted in FIG. 15. The rocker member has two axes of symmetry, namely (w2) and 01-C. The plate has the profiles (e1) and (e1′); these are copied symmetrically to an axis of symmetry (y-y) that is perpendicular to 01-C. The profiles (e1s) and (e1's) are configured. These profiles engage rocker member W2, which was copied symmetrically to the axis (y-y). Thus plate L1 will engage rocker members W1 and W2. Rocker member W1 has the axis of symmetry (w2), and rocker member W2 the axis of symmetry (w2′). Plate 1 is copied symmetrically to (w2) and to (w2′). Plates L2 and L3 are the result. In this manner, the next plates and rocker members of the chain are configured. The thickness and width of the rocker members, the thickness and shape of the plates are determined from strength, acoustics, technology and other criteria. The geometry of the plates can be chosen so that the plates become shorter. That results in better polygonal effects and better acoustics. The pressure angle plays a large role with regard to the design of the shape and the transmission of force.

The relative motion of plate and rocker member can be regarded as centroidal motion of the two centroids, rolling circle (w1) of the plate and rolling straight line (w2) of the rocker member. Since these curves are virtual curves, the active profiles of the two parts, the involutes of the plate and the straight lines of the rocker members, will roll and slide. Despite the sliding motion a high efficiency is achieved, similar to that of the involute engagements. The relative angle between two adjacent plates can be larger or smaller, depending on the pressure angle and the design of the plates and rocker members.

The chain can transmit a tensile force, in which case the axial force (in the tensile direction of the chain) is transmitted from a plate to the rocker member. The rocker member will then place a load on the next plate, which in turn will place a load on the next rocker member. The height of the axial forces and frictional forces is dependent on the pressure angle and length of the plates.

FIG. 17 and FIG. 18 explain the construction of an additional embodiment of the joint. The rolling curves of the centroidal motion are the circle (w1) with the center point 01 and the rolling straight line (w2), with tangents at point C (FIG. 17). The line of action (g) is tangential at A in the case of the base circle (g1), and contains the instantaneous center of rotation C of the relative motion of the rolling circle (w1) and of the rolling straight line (w2). A point K on the line of action describes the involute (e1) during its rolling motion on the base circle. Together with the line of action, a generating line (g-g) is regarded vertically at point K. During the rolling motion of the line of action (g) on the rolling circle (w1), the generating line (g-g) will describe the same involute (e1). Thus the involute (e1) and the generating line (g-g) are reciprocally contoured curves. The two reciprocally contoured curves are in contact at point K. Rocker member W12 is configured so that it contains the generating line as an active profile. The involute (e1) and the active profile of the rocker member are copied symmetrically to the axis 01-C. This results in the profiles (g-g′) and (e1′). Thus one obtains an involute gear wheel and rack meshing. The rolling circle and the rolling straight line are the virtual centroids of the relative motion of plate and rocker member. Plate 1 will contain the two involute profiles of the engagement, and the rocker member will contain the two generating lines. The left profile of the plate, the curves (I1) and (I1′), are designed so that they do not collide with the adjacent rocker member. The rocker member has two axes of symmetry: (y-y) perpendicular to 01-C, and 01-C. The plate profiles (e1) and (e1′) are copied symmetrically to the axis (y-y). The profiles (e2) and (e2′) are configured. These profiles are part of plate L2, and are engaged with rocker member W12. Rocker member W12 engages plates L1 and L2. Rocker member W12 is copied symmetrically to axis (w2) and forms the rocker member W23. In just the same way, the profiles of plate L2, (e2) and (e2′), are copied symmetrically to axis (w2). Thus the entire length of the plate is configured. Similarly, plate L1 is configured. Plate L1 is copied symmetrically from (w2) and forms the plate L3. One can see that rocker member W12 engages plates L1 and L2 and that rocker member W23 engages plates L2 and L3. In this manner, the next plates and rocker members of the chain are configured. The thickness and width of the rocker members, the thickness and shape of the plates are determined from strength, acoustics, technology and other criteria. The geometry of the plates can be chosen so that the plates become shorter (FIG. 18). That results in an improvement to the polygonal effect and to better acoustics. The pressure angle is important for the design of the shape and the transmission of force.

The relative motion of plate and rocker member can be regarded as centroidal motion of the two centroids, rolling circle (w1) of the plate and rolling straight line (w2) of the rocker member. Since these curves are virtual curves, the active profiles of the two parts, the involutes of the plate and the straight lines of the rocker members, will roll and slide. Despite the sliding motion, efficiency similar to that of the involute engagements is achieved here as well. The relative angle between two adjacent plates can be larger or smaller, depending on the pressure angle and the design of the plates and rocker members.

Reference character list

| | |
|---|---|
| W1, W2, W2′ | rocker members |
| L1, L2, L1′, L2′ | plates and opposing plates |
| (w1), (w2) | rolling circles |
| 01, 02 | center points of the rolling circles |
| (g1), (g2) | base circles of the rolling circles |
| C | instantaneous center of rotation |
| (g) | line of action |
| (e1), (e2), | involutes |
| (e1′), (e2′) | |
| K, Ka, K′, Ka′ | contact points of the sliding motion |
| P1, P2 | contact points of the rolling motion |
| Z1, Z1′, Z2, Z2′ | segments (gear wheel segments) |

1: A plate-link chain comprising: a plurality of plates that are connected with each other by a hinge joint including at least a first rocker member that can roll with a first rolling profile on a second rolling profile of an opposing plate, wherein the first rocker member is in contact with the opposing plate on at least two other contact points and the surface contours of the opposing plate and of the first rocker member in a region adjacent to the contact points are reciprocally contoured curves, wherein one of the rolling profiles is concave and one of the rolling profiles is convex.

2: A plate-link chain in accordance with claim 1, wherein the reciprocally contoured curves are each involutes of base circles associated with the rolling profiles.

3: A plate-link chain in accordance with claim 1, wherein the reciprocally contoured curves are contours of a family of involutes through surface points of the opposing plate or of the first rocker member.

4: A plate-link chain in accordance with claim 1, wherein the rolling profile of the first rocker member is convex and the rolling profile of the opposing plate is concave, or that the rolling profile of the rocker member is concave and the rolling profile assigned to the opposing plate is convex.

5: A plate-link chain in accordance with claim 1, wherein a common normal of the contour of the first rocker member and of the contour of the opposing plate at the contact points passes through the instantaneous center of rotation.

6: A plate-link chain in accordance with claim 1, wherein an additional rocker member is in contact with the opposing plate.

7: A plate-link chain in accordance with claim 6, wherein the first rocker member is firmly connected to the plate and the additional rocker member is firmly connected to the opposing plate.

8: A plate-link chain comprising: a plurality of plates connected with each other by at least one first rocker member, wherein the rocker member slides with a rolling profile on a rolling profile on an opposing plate, and wherein the rolling profile is in contact with the rolling profile of the opposing plate on at least two points, where the surface contours of the rolling profiles in a region adjacent to the contact points are reciprocally contoured curves.

9: A plate-link chain in accordance with claim 1, wherein a common normal of the contour of the rolling profiles at the contact points passes through the instantaneous center of rotation.

10: A plate-link chain in accordance with claim 1, wherein one of the rolling profiles is concave and the other of the rolling profiles is convex.

11: A plate-link chain in accordance with claim 1, wherein the first rocker member is not firmly connected with any of the plates, and wherein both plates have rolling profiles on which rolling profiles of the first rocker member can roll or slide.

12: A plate-link chain in accordance with claim 11, wherein the rolling profiles are situated on rocker members that are firmly connected to the respective plates.

13: A plate-link chain in accordance with claim 11, wherein both rolling profiles of the first rocker member are convex, and the rolling profiles of the rocker members of the plates are concave.

14: A plate-link chain in accordance with claim 11, wherein both rolling profiles of the first rocker member are concave, and the rolling profiles of the rocker members of the plates are convex.

15: A plate-link chain in accordance with claim 11, wherein the first rocker member is in sliding contact with both plates at two points each, and rolls against both rolling profiles at one point each.

16: A plate-link chain in accordance with claim 11, wherein the first rocker member is in sliding contact with both rolling profiles at two points each.

17: A plate-link chain in accordance with claim 1, wherein the plates are engaged by the rocker members.

18: A plate-link chain in accordance with claim 1, wherein in each case two opposing rocker members are firmly connected with each other.

19: A plate-link chain comprising: a plurality of plates that are connected with each other by rocker members forming hinge joints, wherein the rocker members engage the plates.

20: A plate-link chain in accordance with claim 19, wherein the surface contours of the plates and of the rocker members in a region adjacent to the contact points are reciprocally contoured curves, and one of the rolling profiles is concave and one of the rolling profiles is convex.

21: A plate-link chain in accordance with claim 20, wherein the rolling profiles of the plates are concave and the rolling profiles of the rocker members are convex.

22: A plate-link chain in accordance with claim 20, wherein the rolling profiles of the plates are convex and the rolling profiles of the rocker members are concave.

23: A conical pulley transmission comprising: a pair of pulleys, and a plate link chain having a plurality of plates that are connected with each other by a hinge joint including at least a first rocker member that can roll with a first rolling profile on a second rolling profile of an opposing plate, where the first rocker member is in contact with the opposing plate on at least two other contact points and the surface contours of the opposing plate and of the first rocker member in a region adjacent to the contact points are reciprocally contoured curves, wherein one of the rolling profiles is concave and one of the rolling profiles is convex.
